(19) United States
(12) Patent Application Publication
(10) Pub. No.: US 2014/0195399 A1
(43) Pub. Date: Jul. 10, 2014

(54) METHOD AND SYSTEM FOR ACHIEVING POSITIVE NET PROFITS STATISTICALLY

(71) Applicants: Chuan Wang, Lexington, MA (US); Andrew Ming Wang, Lexington, MA (US)

(72) Inventors: Chuan Wang, Lexington, MA (US); Andrew Ming Wang, Lexington, MA (US)

(21) Appl. No.: 13/734,900

(22) Filed: Jan. 4, 2013

(51) Int. Cl. G06Q 40/04

(52) U.S. Cl. CPC G06Q 40/04
USPC 705/37

(57) ABSTRACT

This invention discloses an investment method for achieving consistent positive profits, positive net profits, or “absolute return”, statistically. It begins with evaluating a trading system. Average and standard deviation are calculated from occurred individual trading profits to estimate expected average profit and risk. Expected cumulative profits and cumulative standard deviations are then estimated from their corresponding individual counterparts. An expected performance map may be constructed with the expected cumulative profit and lower profit limit plots. To ensure positive net profits can be achieved, a high probability confidence level is specified, and a lower profit limit is estimated. If the expected average profit is positive, expected cumulative profits will continuously increase. After sufficient trades, the lower profit limit will also increase and eventually become positive. Whereby, positive net profits can be achieved with high probability, while risk is limited by the lower profit limit. Thus risk occurs at a low probability.

### CROSS-REFERENCE TO RELATED APPLICATIONS

Not Applicable

### FEDERAL SPONSORED RESEACH

Not Applicable

### INCORPORATION-BY-REFERENCE OF LARGE TABLE SUBMITTED

Large tables are submitted to constitute a part of the specification of this invention, and are incorporated by reference herein for all purposes. The large tables are in the following computer files for carrying out embodiments of the invention:
Table1.txt, Table2.txt, Table3.txt, and Table4.txt correspond to Tables 1-4 that lists all trading profits by trading the e-mini S&P-500 (ES) and Nasdaq-100 (NQ) future contracts of 2007 4^{th} Quarter expiration with the trading systems 1-4, respectively. These computer files were created on Dec. 1, 2011. Table1.txt, Table2.txt, Table3.txt, and Table4.txt are 907, 725, 565, 428 bytes in size, respectively.

### FIELD OF THE INVENTION

This invention relates generally to financial business methods, specifically to security trading for investment.

### BACKGROUND OF THE INVENTION

In the financial markets, prices of securities fluctuate randomly. For example, stock prices generally fluctuate randomly with approximately equal chances of increasing and decreasing in value most of the time so that future prices cannot be exactly predicted. As a result, it is extremely difficult for an investor to make profit by trading.

Efficient Market Hypothesis is a well-known theory in finance. It asserts that securities prices are always fair and reflect all known information about their economic prospects. The theory concludes that it is impossible for any investor to reliably and consistently outperform the market except by luck.

However, many financial professionals believe that the markets are not perfectly efficient. Securities prices may occasionally deviate from their fair values. Greed and fear of investors may cause such a market condition. Many investors thus utilize various techniques to search for price moving direction or undervalued and overvalued securities in order to make profits from what they believe are temporary deviations from their fair prices. The interest and importance of making profit in finance are so great that it requires no further emphasis.

Probability is an abstract mathematical concept that is used to define a chance that an uncertain event will happen. Probability Theory and Statistics has been used pervasively in natural sciences and engineering. Probability or probability distribution can be estimated by counting relative frequencies observed. Thus, the observed frequency distribution can be utilized to make prediction about the frequency distribution of the future results based on the past occurrences. Such an objective interpretation of probability has a wide variety of practical applications that result in valuable and useful predictions.

From a point view of Probability Theory, results of a trading system may be considered as a random variable because of its uncertainty in nature. A trading system is a predetermined trading method consisting of a set of rules that clearly define entry and exist of a trading position. Trading results can be thus characterized in terms of probability, including sample average, sample standard deviation, as well as frequency distribution.

This invention will make use of objectively estimated probability to make prediction about the future performance. It provides a method for investors to make positive net profits statistically. The phrase of “to make positive net profits statistically” used here means that, after a sufficiently large number of trades, the total gains are significantly greater than the total losses.

### OBJECTS AND ADVANTAGES

Accordingly, a main object of the present invention is to provide a method and a system for achieving positive net profits statistically.

An important object of the invention is to provide a method to estimate the potential average rate of return and potential risks of a trading system.

Another important object of the invention is to provide a method to estimate lower limit of cumulative profit with a specified high probability confidence level.

Further advantages of the present invention will become apparent from a consideration of the attached drawings and ensuing descriptions.

### BRIEF SUMMARY OF THE INVENTION

The present invention provides an investment method and a system for achieving positive net profits after a sufficiently large number of trades. The method may use one or more trading systems, and begins with evaluating each of these trading systems. Based on past occurrences, average and variability of individual trading profits, and profit frequency distribution are calculated. Expected cumulative profits, cumulative variability, and cumulative profit frequency distributions of the trading system are then estimated from their individual counterparts. To ensure that positive net profits can be achieved, a high probability confidence level is specified. At the specified confidence level, a lower limit of cumulative profit is estimated. An expected performance map is then constructed with the expected cumulative profit and lower profit limit plots. When the expected average profit is positive, the expected cumulative profits will continuously increase. After sufficient trades, the lower profit limit will also increase and eventually become positive and beyond zero. As a result, a positive net profit can be achieved with high probability, while risk is limited by the lower limit of cumulative profit. Thus risk occurs at a low probability.

### DESCRIPTION OF THE SEVERAL VIEWS OF THE DRAWING

FIG. 1 shows a flow chart diagram of the method that implements the present invention.

FIG. 2 shows the prices of e-mini S&P-500 future contract of 2007 4^{th} Quarter expiration.

FIG. 3 shows the prices of e-mini Nasdaq-100 future contract of 2007 4^{th} Quarter expiration.

FIG. 4 shows the profit frequency distributions of the individual and composite trading systems.

FIG. 5 shows the expected performance map by using a trading system.

FIG. 6 shows the expected performance map by using a composite trading system.

FIG. 7 shows the cumulative profit frequency distributions that are calculated by the convolution from the profit frequency distribution of a single trade.

### DETAILED DESCRIPTION OF THE INVENTION

### A. Reasoning

An object of the present invention is to provide investors with a method to achieve reasonably consistent profits, or positive net profits statistically. There are two requirements to achieve positive net profits. First, after a sufficiently large number of trades, the total gains must be significantly greater than the total losses. As the total gains are significantly greater than total losses, the trading system has a higher probability of making profits and winning.

Second, trading risks must be rigorously controlled. Controlling risk is essential for any investment. Otherwise, even having a trading system with a high probability, significant amount of money can be lost quickly if the risk is not carefully managed.

To help understand these two requirements, a dice game is chosen for illustration. Investor gains his bet when the dice shows 1, 2, 3, or 4. But investor loses his bet when the dice shows 5 or 6. This is a game that has a gain-to-loss ratio of 2:1. Even with a very high probability game, investor should not take high risk. For example, he should not bet 100% of his capital each time. This is because he needs only one occurrence of bad luck to lose all his money. Similarly, he may lose a substantial amount of capital if he takes a large percentage of risk.

In contrast, if the investor only bets 5% of his capital each time, he will almost have no chance, with a probability of near zero, to lose all of his money. Based on Probability Theory, after a large number of bets, total number of winning will be approximately two times of the total number of losing. After a large number of bets, about ⅔ of bets will be winning and about ⅓ of bets will be losing. As a result, the averaged net gain for every three rolls is 5% in this example. After a large number N of bets, the total gains will be approximately N/3 times 5%.

In case of a high probability game with the two above requirements met, leverage can be used to improve capital efficiency. To help understand this, a game similar to the market exchange that allows investors to bet up to 5 times of his capital is chosen for illustration. Investor gains 1% of his bet when the dice shows 1, 2, 3, or 4. On the other hand, investor loses 1% of his bet when the dice shows 5 or 6. Similar to the previous game, the investor decides to limit his risk to 5% of his capital for each bet so that he will almost have a probability of near zero to lose all his money. Because the investor decides to bet 5 times his capital each time, he will gain 5% instead of 1% or lose 5% instead of 1% each time. As a result, leverage amplifies both gain and loss. The averaged net gain for every three rolls is also 5% instead of 1%. After a large number N of bets, the total gains will be approximately N/3 times 5%, too.

In contrast, this game without leverage only provides a net gain of 1%. Although winning/losing ratio remains 2:1, gain and loss for each bet remain at 1%. The averaged net gain for every three rolls remains at 1%. After a large number N of bets, the total gains will be approximately N/3 times 1%.

To achieve positive net profits in a long run, a trading system must have a high probability to generate profit. At the same time, trading risks must be controlled to an acceptable level. Therefore, one of the major tasks of the method is to estimate expected average profit for a trading system. Another task is to estimate associated trading risks. Alternatively, considering a “worst case” scenario, one may specify a high probability confidence level, and then determine lower limit of potential cumulative profits.

### B. General Operational Procedure

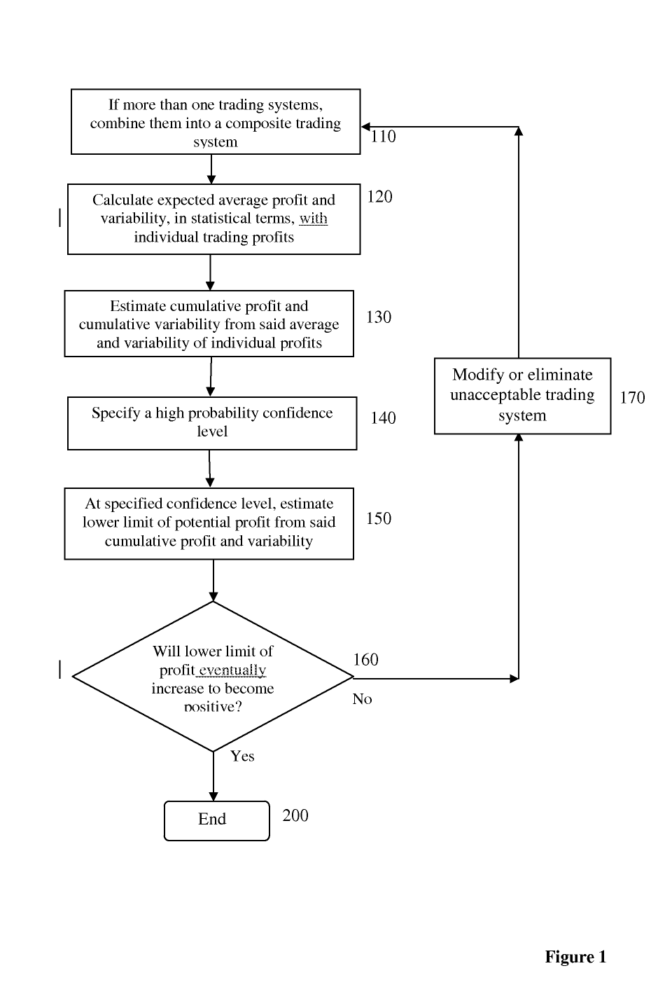

FIG. 1 illustrates a general procedure that implements the present invention. First, in Step 110, if there is more than one trading systems, combine them into a composite trading system. Next, in Step 120, calculate the average and variability of individual trading profits for each trading system in statistical terms. For a composite system, calculate combined expected average and variability of all individual trading profits. The expected average profit may be estimated in terms of the average of all individual profits occurred. The variability may be estimated in terms of standard deviation, dispersion, or variance of the individual profits. The variability may be used as an estimate for potential trading risks. Then, in Step 130, estimate expected cumulative profit and cumulative variability from said individual average profit and variability. The expected cumulative profits may be estimated as compounded return based on the average of the individual profits. The cumulative variability may be estimated as the cumulative standard deviation from the standard deviation over the individual profits. The cumulative variability may be used as estimate for potential cumulative risks.

To evaluate how reliable the estimates are, a high probability confidence level is specified in Step 140. In the next Step 150, at the specified confidence level, lower limit of potential cumulative profit is estimated from the expected cumulative potential profits and cumulative variability. Lastly, evaluate if the lower limit of the expected cumulative profit will increase so that it eventually becomes significantly positive, in Step 160. As a result, the method would have a high probability of producing positive net profits after sufficient trades. If the result is not acceptable, the unacceptable trading systems must be eliminated or modified until it becomes acceptable.

As described in detail below and because a large number of complicated calculations are involved, the embodiments of this invention may be implemented by using a computer equipped with one or more processors, memory, and storage devices.

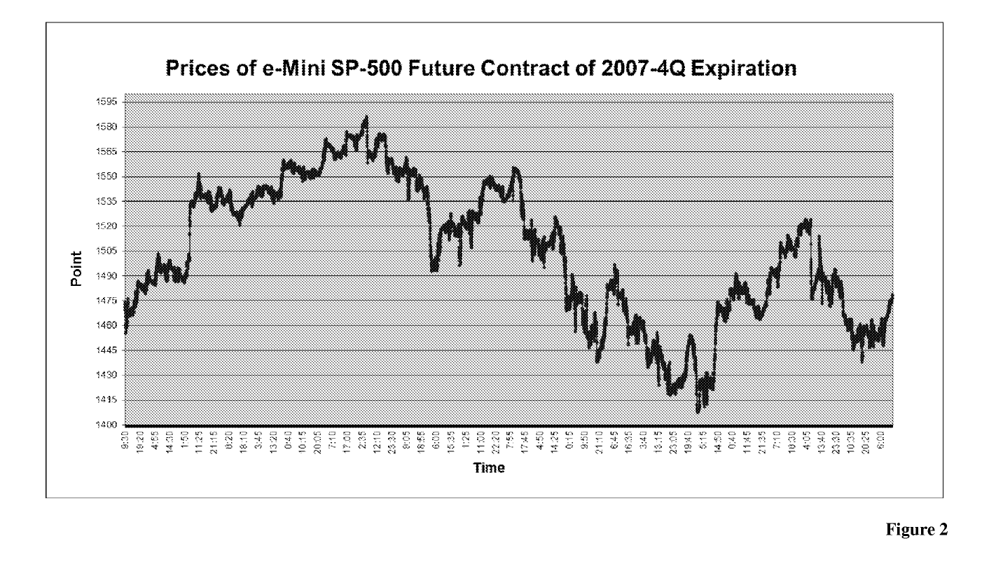

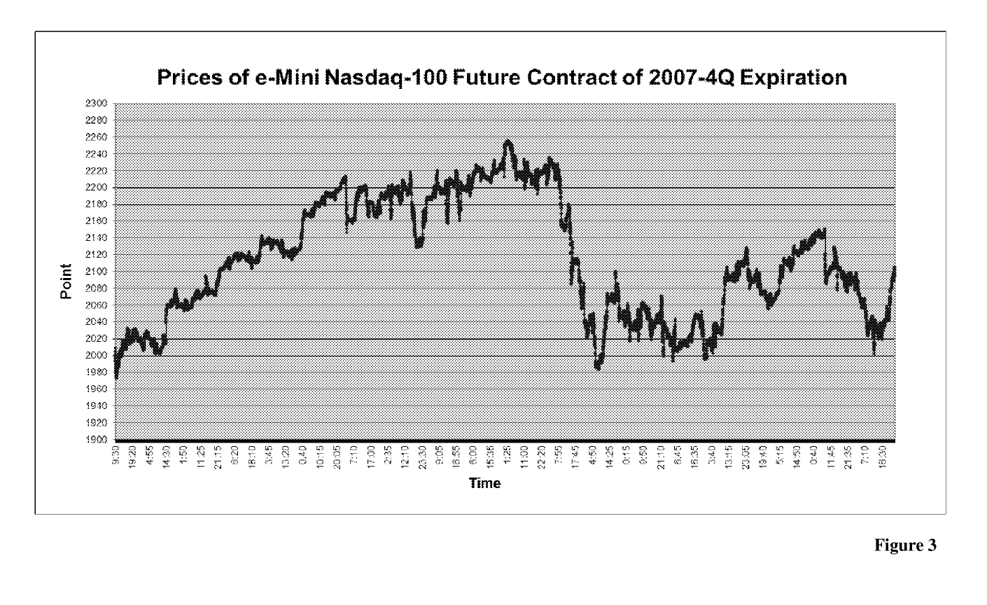

To illustrate how to implement the present invention, e-mini S&P-500 (ES) and Nasdaq-100 (NQ) future contracts of 2007 4th Quarter expiration are used as examples and shown in FIGS. 2 and 3, respectively. In this illustration, an exemplary system is used to evaluate overpriced and underpriced conditions statistically for both S&P-500 and Nasdaq-100 futures. For the underpriced conditions, a long strategy is chosen to buy future contracts first, and then sell them all at a later time to make profits. For the overpriced conditions, a short strategy is chosen to sell future contracts first, and then buy them back at a later time to lock in profits. Thus, there are four trading systems, the long S&P-500 strategy for the underpriced data group, the short S&P-500 strategy for the overpriced data group, the long Nasdaq-100 strategy for the underpriced data group, and the short Nasdaq-100 strategy for the overpriced data group, to be chosen to illustrate the operation. Some statistical parameters of these four trading systems and a composite trading system are calculated by the procedure described above and summarized in Table 5.

TABLE 5
Performance of the Individual and Composite
Trading Systems

| | | | | | long ES + |
|---|---|---|---|---|---|
| | long | short | long | short | short ES + |
| | ES | ES | NQ | NQ | long NQ |
| total net profit % | 6.8 | 7.1 | 5.8 | 1.1 | 19.7 |
| average profit % | 0.19 | 0.25 | 0.27 | 0.07 | 0.23 |
| standard deviation % | 0.510 | 0.445 | 0.515 | 0.461 | 0.492 |
| total gains % | 11.7 | 9.3 | 8.0 | 3.3 | 29.0 |
| total losses % | −4.9 | −2.2 | −2.2 | −2.2 | −9.4 |
| largest gain % | 1.2 | 1.1 | 1.1 | 0.9 | 1.2 |
| largest loss % | −1.0 | −0.9 | −0.7 | −1.0 | −1.0 |
| total # of trades | 36 | 28 | 21 | 15 | 85 |
| # of winning trades | 23 | 19 | 14 | 7 | 56 |
| # of losing trades | 13 | 9 | 7 | 8 | 29 |
| gain/loss ratio | 2.4:1.0 | 4.1:1.0 | 3.6:1.0 | 1.5:1.0 | 3.1:1.0 |
| winning/losing ratio | 1.8:1.0 | 2.1:1.0 | 2.0:1.0 | 0.9:1.0 | 1.9:1.0 |

For each trading system, the expected average profit can be estimated by averaging over all the individual profits occurred. As shown in Table 5, the individual average profits of all the individual trading systems except for the short NQ, ranging from 0.19% to 0.27%, are significant compared to their corresponding standard deviations. All three of these trading systems have total gains that are significantly greater than the corresponding the total losses. The gain/loss ratios for these three systems are significantly greater than the overall market average of 1:1, ranging from 2.4:1.0 to 4.1:1.0. The winning/losing ratios for these three systems are also significantly greater than the overall market average of 1:1, ranging from of about 1.8:1.0 to 2.1:1.0. The gain/loss ratios are calculated from the total gains and losses. The winning/losing ratios are calculated from the total numbers of winning trades and of the losing trades. Such high gain/loss and winning/losing ratios suggest that each of these systems may generate potential positive net profits with high probability.

For each trading system, potential individual trading risks can be estimated by the standard deviation of the corresponding individual trading profits occurred. As shown in Table 5, the sample standard deviations of these systems range from 0.445 to 0.515. The largest losses, about 1.0% for these systems, can be also used to estimate potential individual trading risks for a “worst case” scenario.

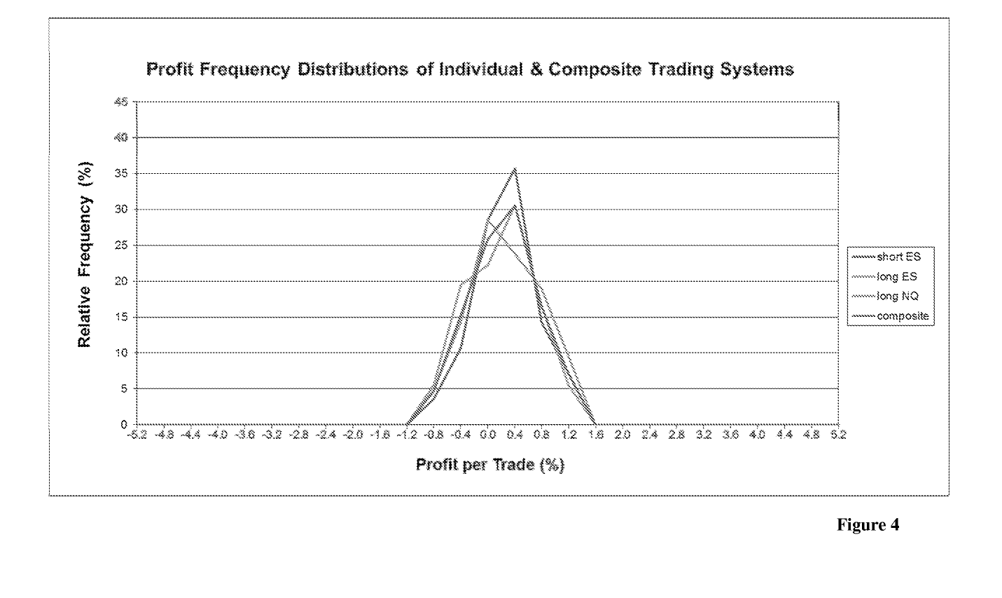

The profit frequency distributions of these trading systems are shown in FIG. 4. As shown in FIG. 4, these profit frequency distributions are symmetric mound-shaped curves.

### C. Single System Embodiment

As discussed above, any of the three individual trading systems with high gain/loss and winning/losing ratios can be used to illustrate the method. However, only the long ES system is chosen to illustrate how to implement this invention. As shown in Table 5, the individual average profit and the standard deviation of the long ES strategy are 0.19 and 0.510, respectively. They are used to estimate expected cumulative profits and cumulative standard deviations.

After N trades with a fixed amount of investment capital, the expected cumulative profit, R, may be estimated as N times of the individual average profit, R. In this illustration, as shown in Table 5, the individual average profit (Rᵢ) is 0.19%. On the other hand, after N trades with fully invested capital, the expected cumulative profit may be estimated as compounded rate of return, R, based on the estimated individual average profit, R, with the following formula in percentage:

R_{c}=(1+Rᵢ)^{N}−1.

R_{c} is merely a fair estimate of the expected cumulative profit.

The expected cumulative profit represents the center of the cumulative profit frequency distribution as shown in FIG. 4. The probability of the future cumulative profit being greater than this estimate is 50%. And the probability of the future cumulative profit being less than this estimate is also 50%. Because the actual profit may differ from this estimate, it is desirable to estimate degree of incorrectness for this estimate. Cumulative variability may be used to estimate such a degree of incorrectness for the estimated cumulative profit.

The cumulative variability may be estimated as cumulative standard deviation. The cumulative standard deviation may be calculated from corresponding individual standard deviation. The cumulative variability may be used to estimate potential cumulative risks. After trading N times, the cumulative standard deviation may be estimated as the square root of N times of the individual standard deviation. This is because Probability Theory provides that standard deviation increases in proportion with the square root of the number of trials. After N trades, cumulative standard deviation may be calculated with the following formula:

D_{c}=Dᵢ×N^{1/2}

where D_{c} is cumulative standard deviation and Dᵢ is individual standard deviation. In this illustration, as shown in Table 5, the individual standard deviation (Dᵢ) is 0.510%.

To estimate lower limit of potential profit, an investor may specify a high probability confidence level. With the specified confidence level, lower limit of potential profit, R₁₁, may be calculated as the expected cumulative profit minus M times of the corresponding cumulative standard deviation, by the following formula:

R₁₁=R_{c}−D_{c}×M

where M is a real number.

Based on Probability Theory, when M is chosen to be greater than 2, a high probability for the specified confidence level is mathematically warranted. Because the profit frequency distribution is approximately symmetric and mound-shaped, the empirical rule of Probability Theory may apply. If the confidence level is specified at 97.5%, the empirical rule suggests that the potential cumulative risk will be approximately two times of the cumulative standard deviation. If the confidence level is specified at 99.8%, the empirical rule suggests that the potential cumulative risk will be approximately three times of the cumulative standard deviation.

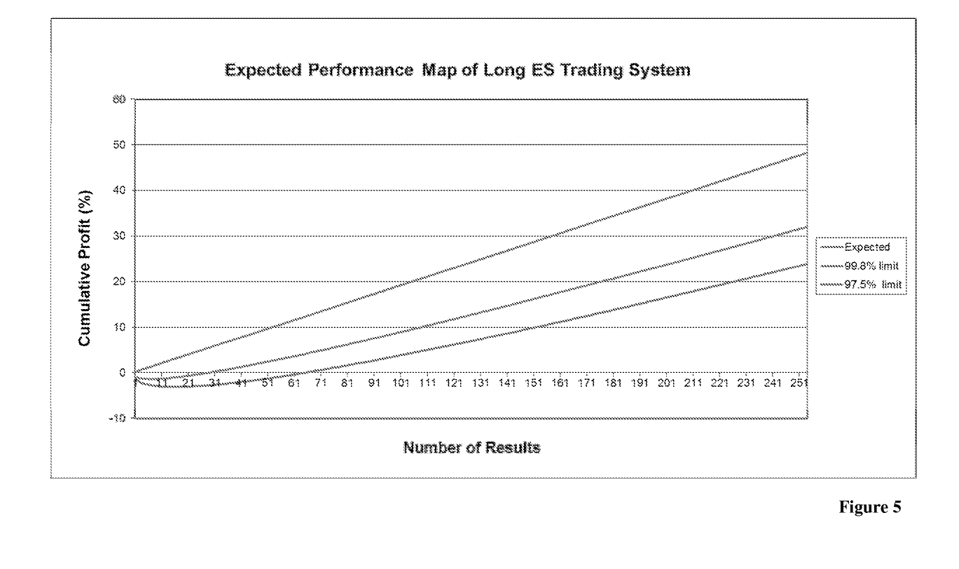

As a result, by specifying a confidence level of 99.8%, the lower limit of the potential profit is thus calculated and shown in FIG. 5. This invention provides investor a method to estimate lower limit of the potential profit with a high probability confidence level specified by him.

In FIG. 5, an expected performance map is constructed with the expected cumulative profit and the lower profit limit plots. The expected cumulative profit is calculated as N times of the individual average profit, 0.19%. The lower profit limit is calculated as the expected cumulative profit minus three times of the cumulative standard deviation, 0.510%. As long as the individual average profit is positive, the expected cumulative profit plot continuously increases. Similarly, after sufficient trades, the lower profit limit plot also increases, eventually becomes positive and beyond zero. After sufficient trades, about 99.8% of future results will occur above the lower profit limit plot. In a “worst case” scenario, about 0.2% of future results may occur below the lower profit limit plot. Therefore, the future results would be profitable at a probability of 98.8%, that is, above the lower profit limit.

### D. Multiple System Embodiment

When having multiple trading systems, they may be combined into a composite one. In this illustration, only those three systems with gain/loss and winning/losing ratios significantly greater than 1:1 are used to be combined into a composite trading system. As shown in Table 5, the combined average profit, standard deviation, gain/loss ratio, and winning/losing ratio are 0.23, 0.492, 3.1:1.0, and 1.9:1.0, respectively. An average of three positive real numbers must be positive. Further, by a deductive reasoning, such as Mathematical Induction, one may comprehend that, for a composite system consisting of multiple individual trading systems, the composite average profit must be positive if every individual one is positive.

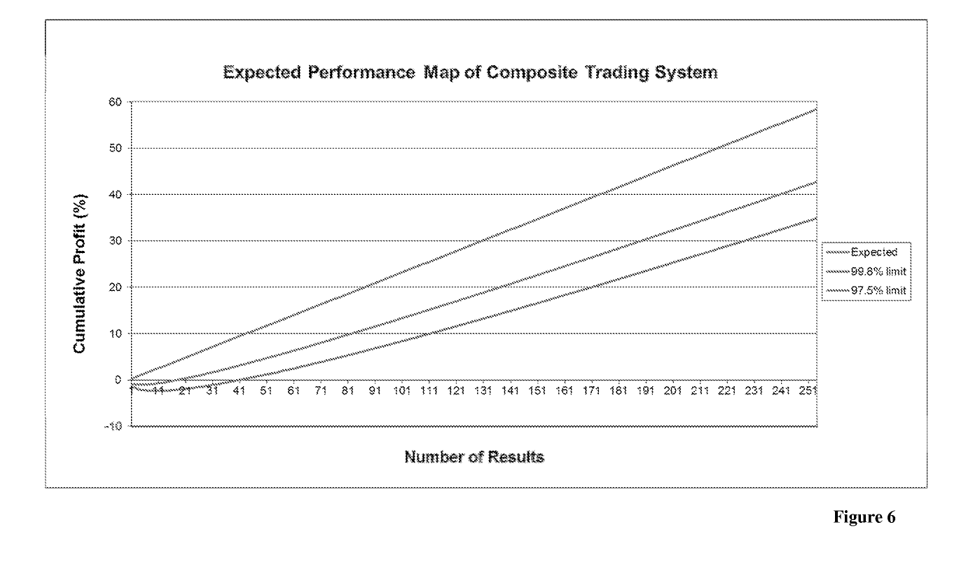

FIG. 6 shows the estimated potential cumulative profits and the corresponding lower profit limit. The expected cumulative profit is calculated as N times of the individual average profit, 0.23%. The lower limit of cumulative profit is calculated as the expected cumulative profit minus three times of the cumulative standard deviation, 0.492%. When the individual average profit is positive, the expected cumulative profit plot continuously increases. After sufficient trades, the lower profit limit plot also increases, eventually becomes positive and beyond zero. After sufficient trades, about 99.8% of future results will occur above the lower profit limit plot. In a “worst case” scenario, only about 0.2% of future results may occur below the lower profit limit plot. Therefore, the future results would be profitable at least at a probability of 98.8%, including anything above the lower profit limit and more after sufficient trades.

As shown in FIG. 4, the profit frequency distribution of the composite system is also approximately symmetric and mound-shaped, similar to those of the individual trading systems. Such mound-shaped profit frequency distribution suggests that the composite system may produce a potential positive net profit after a sufficient large number of trades. Alternatively, the composite individual average profit and standard deviation may be approximately made by simply averaging their counterparts of all the individual trading systems. The averaged results, including the averaged profit of 0.24, the averaged standard deviation of 0.490, the averaged gain/loss ratio of 3.4:1.0, and the averaged winning/losing ratio of 2.0:1.0, are very consistent with those calculated in Table 5.

### E. Alternative Estimating Profits and Risks

Alternatively, potential profits and risks can be estimated from profit frequency distributions. A profit frequency distribution can be calculated by counting the number of times occurred in each equal profit interval. The relative profit frequency distribution can be calculated in percentage by dividing the profit frequency distribution by the total number of the data. As shown in FIG. 4, the center of the frequency distribution corresponds to the average of data. The half-width of the frequency distribution corresponds to the standard deviation of data.

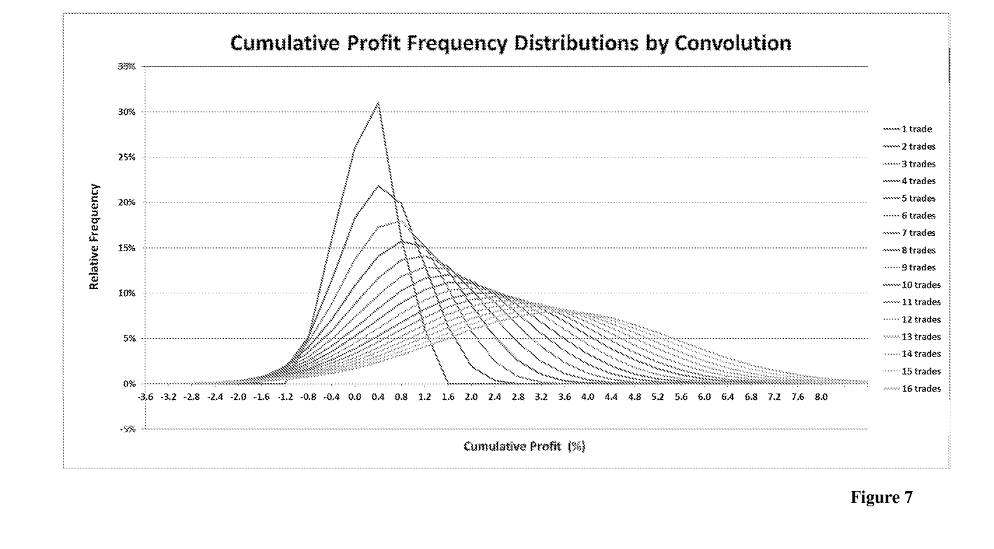

FIG. 7 shows the cumulative effects on profit frequency distribution of a trading system. A cumulative frequency distribution of two independent trades can be calculated by the convolution, a mathematical operation, of the single trade profit frequency distribution with itself. The cumulative frequency distribution of N+1 independent trades is thus resulted from the convolution of the cumulative frequency distribution of N trades with said single trade frequency distribution. The cumulative profits and deviations can be calculated from these cumulative frequency distributions. The cumulative profit may be calculated from the center of the corresponding cumulative frequency distribution. The cumulative standard deviation may be calculated from the half-width of the corresponding cumulative frequency distribution. As a result, the expected cumulative profit plot can be made from the calculated cumulative profits. Based on these cumulative frequency distributions, at specified high probability confidence level, the lower profit limit plot can be estimated from the expected cumulative profits and the cumulative standard deviations.

### CONCLUSION, RAMIFICATIONS, AND SCOPE OF INVENTION

Accordingly, the reader will realize that the method disclosed above can be used to achieve positive net profits statistically. To determine if a trading system or composite system can be used to achieve positive net profits statistically, an expected performance map may be constructed by calculating a cumulative profit plot and a lower profit limit plot. Such an expected performance map is particularly useful for guiding the implementation of the method.

Although this invention has been described in terms of its embodiments with a certain degree of particularity, it is not intended that the invention be limited to these embodiments as illustrated. Modification within the spirit of the invention will be apparent to those skilled in the art. It is to be understood that numerous changes in the details of operational procedures, or in choice of statistical terms, may be made but without departing from the spirit and scope of the invention. For example, a composite system may be constructed by combining individual trading systems with different weights, instead of with even weights as illustrated. For instance, one may simply choose more weight for long trading systems than short trading systems. Also the cumulative profit plot may be made in different forms of return, other than the simple sum return and compound return. Cumulative variability may be calculated in different forms, instead of standard deviation, such as variance. Although the probability confidence levels are chosen for 97.5% and 99.8% in the above illustrations, other high probability levels may be chosen but without departing from the spirit and scope of the invention. For example, one may choose 95% or 98%. Although the lower limit levels are made by two and three times of standard deviation in the above illustrations, a scale factor other than two or three can be simply used but without departing from the spirit and scope of the invention. For example, 2.5, 4.0, or other values can be used instead of 2 or 3. Clearly, modification of the scale factor or different but similar forms of deviation for measurement of dispersion of individual results may be made without departing from the spirit and scope of the invention.

The detailed description above is exemplary but not restrictive of the invention as claimed. The drawings, together with the detailed descriptions, illustrate a number of embodiments that serve to explain the general principles of the present invention, and to teach those skilled in the field to employ the present invention. The scope of the invention should be thus determined by the claims and their legal equivalents, rather than by the given examples.

We claim:

1. A method for achieving a positive net profit statistically, comprising the steps of:
(a) calculating expected average profit and variability from occurred and or would have occurred individual trading profits;
(b) estimating expected cumulative profit and cumulative risks from said individual expected average profit and individual variability;
(c) specifying a high probability confidence level;
(d) at said confidence level, estimating lower limit of cumulative profit based on said expected cumulative profits and said cumulative risks;
(e) evaluating if said lower limit of cumulative profit will increases, and eventually becomes positive,
whereby a positive net profit can be achieved with a high probability, with said expected cumulative profits, beyond said lower limit of cumulative profit at said specified high probability confidence level, with said cumulative risks at a low probability.

2. The method as described in claim 1, further comprising the step of:
determining winning/losing ratio over a sufficiently large number of trades;
whereby a positive net profit can be achieved with high probability by said investment method statistically.

3. The method as described in claim 1, further comprising the step of:
determining gain/loss ratio over a sufficiently large number of trades;
whereby a positive net profit can be achieved with high probability by said investment method statistically.

4. The method as described in claim 1, wherein said investment method is for use in one or more of the uses in the group consisting of security trading, investment for profits, automated trading, algorithmic trading, and or investment for reducing risks.

5. A method using a plurality of trading systems for achieving a positive net profit statistically, comprising the steps of:
(a) combining the plurality of trading systems into a composite trading system;
(b) calculating expected average profit and variability from occurred and or would have occurred individual trading profits;
(c) estimating expected cumulative profit and cumulative risks from said individual expected average profit and individual variability;
(d) specifying a high probability confidence level;
(e) at said confidence level, estimating lower limit of cumulative profit based on said expected cumulative profit and said cumulative risks;
(f) evaluating if said lower limit of cumulative profit will increase, and eventually becomes positive,
whereby a positive net profit can be achieved with a high probability, with said expected cumulative profits, beyond said lower limit of cumulative profit at said specified high probability confidence level, with said cumulative risks at a low probability.

6. The investment method as described in claim 5, further comprising the steps of:
calculating winning/losing ratio for each of the individual trading system over a sufficiently large number of trades,
whereby a positive net profit can be achieved with high probability by said investment method statistically.

7. The investment method as described in claim 5, further comprising the steps of:
calculating gain/loss ratio for each of the individual trading system over a sufficient large number of trades,
whereby a positive net profit can be achieved with high probability by said investment method statistically.

8. The method as described in claim 5, wherein said investment method is for use in one or more of the uses in the group consisting of security trading, investment for profits, automated trading, algorithmic trading, and or investment for reducing risks.

9. A machine using a plurality of trading systems for achieving a positive net profit statistically comprising:
(a) a processor means for processing data;
(b) a storage means for storing data;
(c) first means for combining the plurality of trading systems into a composite trading system;
(d) second means for calculating expected average profit and variability from occurred and or would-occurred individual trading profits;
(e) third means for estimating expected cumulative profit and cumulative risks from said individual average profit and individual variability;
(f) fourth means for specifying a high probability confidence level;
(g) fifth means for estimating lower limit of cumulative profit based on said expected cumulative profits and said cumulative risks at said confidence level;
(h) sixth means for evaluating if said lower limit of cumulative profit will increases, and eventually becomes positive,
whereby a positive net profit can be achieved with a high probability, with said expected cumulative profits, beyond said lower limit of cumulative profit at said specified high probability confidence level, with said cumulative risks at a low probability.

10. The machine as described in claim 9, further comprising:
seventh means for calculating winning/losing ratio over a sufficiently large number of trades,
whereby a positive net profit can be achieved with high probability by said machine statistically.

11. The machine as described in claim 9, further comprising:
eighth means for determining gain/loss ratio over a sufficiently large number of trades;
whereby a positive net profit can be achieved with high probability by said machine statistically.

12. The machine as described in claim 9, wherein said machine is for use in one or more of the uses in the group consisting of security trading, investment for profits, automated trading, algorithmic trading, and or investment for reducing risks.
